(19) United States
(12) Patent Application Publication
(10) Pub. No.: US 2021/0254766 A1
(43) Pub. Date: Aug. 19, 2021

(54) SEAL ASSEMBLY

(71) Applicant: Caterpillar Inc., Peoria, IL (US)

(72) Inventors: John M. MASHAK, Peoria, IL (US); Trevor PEASE, Lafayette, IN (US); Adam P. BERRY, Peoria, IL (US); Hong LIAN, Peoria, IL (US); Gregory O. POTTS, Washington, IL (US)

(73) Assignee: Caterpillar Inc., Peoria, IL (US)

(21) Appl. No.: 16/789,547

(22) Filed: Feb. 13, 2020

(51) Int. Cl. F16L 21/04; F16L 21/03

(52) U.S. Cl. CPC F16L 21/045; F16L 21/03

(57) ABSTRACT

In one aspect, an unloaded annular flexible seal is provided to receive an end of a conduit and to provide a seal between the conduit and a flange of a machine. The seal has a base having an inner surface, an upper surface, an outer surface, and a lower surface, and a leg having an inner surface, an upper surface extending from the inner surface of the base, an outer surface extending from the lower surface of the base, and a lower surface. A surface area of the outer surface of the leg is greater than a surface area of the lower surface of the leg. In another aspect, the seal is included in a seal assembly that also includes an annular back-up member having an L-shaped cross section, including a back-up member base and a back-up member leg configured to sit in the groove of the flexible seal.

### TECHNICAL FIELD

The present disclosure relates generally to a seal assembly, and, more particularly, to a seal assembly that provides a fluid-tight seal between two members.

### BACKGROUND

In connections between two members, such as a conduit and a flange, a fitting may be required to ensure a fluid-tight seal between the two members. This is particularly important for systems in which a highly pressurized fluid, such as a pressurized gas or liquid, flows through the two members, and where the two members may vibrate or otherwise move relative to one another. For example, in a cooling system for a generator, conduits may be used to transfer coolant to and from the generator. The conduits are connected to flanges of the generator using fluid-tight seals and clamps. In such systems, a lack of a fluid-tight seal, or a failure thereof, may result in pressure drops and loss of fluid. Such fluid-tight seals may fail due to misalignments between the two members, due to planar translation or polar tilting (i.e., translation or tilting relative to a longitudinal axis of the flange) either before or after tightening of the clamps. In addition, when a hard joint is used, i.e., a joint by which two metal members are joined by a bolt or a screw, vibrations of one or both of the two members may result in failure of the fluid-tight seals.

Known fittings typically use threaded connections that accommodate some level of misalignment between a conduit and a flange. For example, as described in U.S. Pat. No. 9,267,627 B2 (the “'627 patent”), two conduit gripping devices are used together in a conduit fitting assembly, and are held together as a cartridge or subassembly prior to assembly with the fitting components. One or both of the two conduit gripping devices include a retaining structure by which the devices are mechanically connected together as a subassembly, and may include a front ferrule and a back ferrule that are snapped together as part of a tube fitting.

Using threaded connections in fittings requires additional sealing means to ensure a fluid tight seal between the conduit and the flange. In addition, using rigid components, such as ferrules, reduces an amount by which the fitting can accommodate misalignment and/or vibrations between the conduit and the flange. Further, using a clamp to secure the two members together requires securing a flexible seal between the clamp and the two members. As a connection between the clamp and the two members tightens, the seal may deform to tightly fit against the two members, i.e., to form an interference fit. Problems arise, however, if the connection between a clamp and at least one of the members becomes over-tightened, causing extrusion and possibly failure or breakage of the flexible seal. In addition, as a complexity of such connections increases, it is possible that the connections can be installed and assembled incorrectly, leading to failure or breakage of the flexible seal.

The seal assembly according to the present disclosure may solve one or more of the problems of the devices of the '627 patent, and/or other problems in the art.

### SUMMARY

In one aspect, an unloaded annular flexible seal is provided for use in a seal assembly configured to receive an end of a conduit and to provide a seal between the conduit and a flange of a machine. The seal may include a base having an inner surface, an upper surface, an outer surface, and a lower surface, and a leg having an inner surface, an upper surface extending from the inner surface of the base, an outer surface extending from the lower surface of the base, and a lower surface. A surface area of the outer surface of the leg is greater than a surface area of the lower surface of the leg.

In another aspect, a seal assembly is configured to receive an end of a conduit and to provide a seal between the conduit and a flange of a machine. The seal assembly may have an annular flexible seal that includes a seal base having an inner surface, an upper surface, an outer surface, and a lower surface, and a seal leg having an inner surface, an upper surface extending from the inner surface of the seal base, thereby forming a groove, an outer surface extending from the lower surface of the seal base, and a lower surface. A surface area of the outer surface of the seal leg is greater than a surface area of the lower surface of the seal leg. The seal assembly also includes an annular back-up member having an L-shaped cross section, including a back-up member base and a back-up member leg configured to sit in the groove of the flexible seal.

In still another aspect, a seal assembly is configured to provide a fluid-tight seal between a tube, a flange, and a clamp. The seal assembly may have an annular flexible seal including a seal base having an inner surface, an upper surface, an outer surface, the upper surface and the outer surface being configured to sit in a groove formed by the clamp and the flange, and a lower surface, and a seal leg having an inner surface, an upper surface extending from the inner surface of the seal base, thereby forming a groove, an outer surface extending from the lower surface of the seal base, and a lower surface. A surface area of the outer surface of the seal leg is greater than a surface area of the lower surface of the seal leg. The seal assembly also includes an annular back-up member having an L-shaped cross section, including a back-up member base configured to sit in a groove of the clamp, and a back-up member leg configured to sit in the groove of the seal. When the tube is inserted into the seal assembly, and the tube, the flange, the clamp, and the seal assembly are secured to each other, the seal base is compressed between the clamp, the flange, and the back-up member.

### BRIEF DESCRIPTION OF THE DRAWINGS

FIG. 1 is a schematic drawing of a machine in which a seal assembly, according to the present disclosure, is installed;

FIG. 2 is a cross-sectional plan view of the seal assembly referenced in FIG. 1;

FIG. 3 is a cross-sectional exploded plan view of the seal assembly of FIG. 2;

FIG. 4 is a cutaway cross-sectional view of a back-up ring of the seal assembly of FIG. 2;

FIG. 5 is a cutaway cross-sectional view of a seal of the seal assembly of FIG. 2;

FIG. 6 is a detail cross-sectional plan view of the seal and the back-up ring of the seal assembly of FIG. 2 before tightening of a clamp;

FIG. 7 is a detail cross-sectional plan view of the seal and the back-up ring of the seal assembly of FIG. 2 after tightening of the clamp;

FIG. 8 is a detail cross-sectional plan view of the seal and back-up ring of the seal assembly of FIG. 2 when a tube tilts; and

FIG. 9 is a detail cross-sectional plan view of the seal and back-up ring of the seal assembly of FIG. 2 when the tube translates.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “generally, “substantially,” and “approximately” are used to indicate a possible variation of ±10% in the stated value.

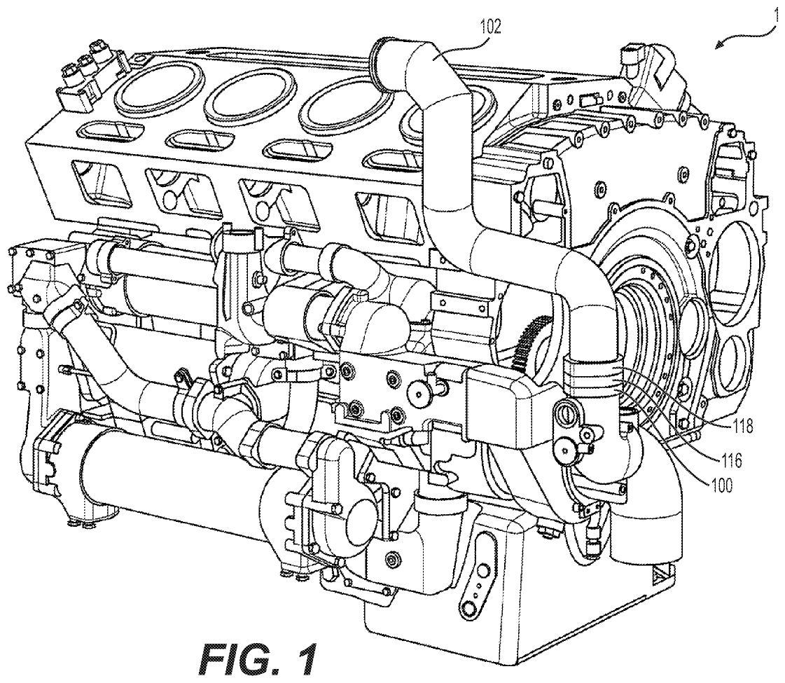

FIG. 1 depicts a sealed coupling 10 provided for a machine 1, such as an engine or a generator. More particularly, FIG. 1 shows the sealed coupling 10 provided between a flange 100 of the machine 1 and a tube or a conduit 102 to prevent leakage of fluid and/or loss of pressure of the fluid flowing between the flange 100 and the tube 102. The flange 100 may form a part of a housing or a block of the machine 1. The tube 102 may be arranged to provide the fluid to, or to receive fluid from, the machine 1. The sealed coupling 10 is a static joint, in that neither of the flange 100 or the tube 102 may rotate or move continuously. The tube 102 may, however, tilt or shift relative to the flange 100, and one or both of the flange 100 and the tube 102 may vibrate.

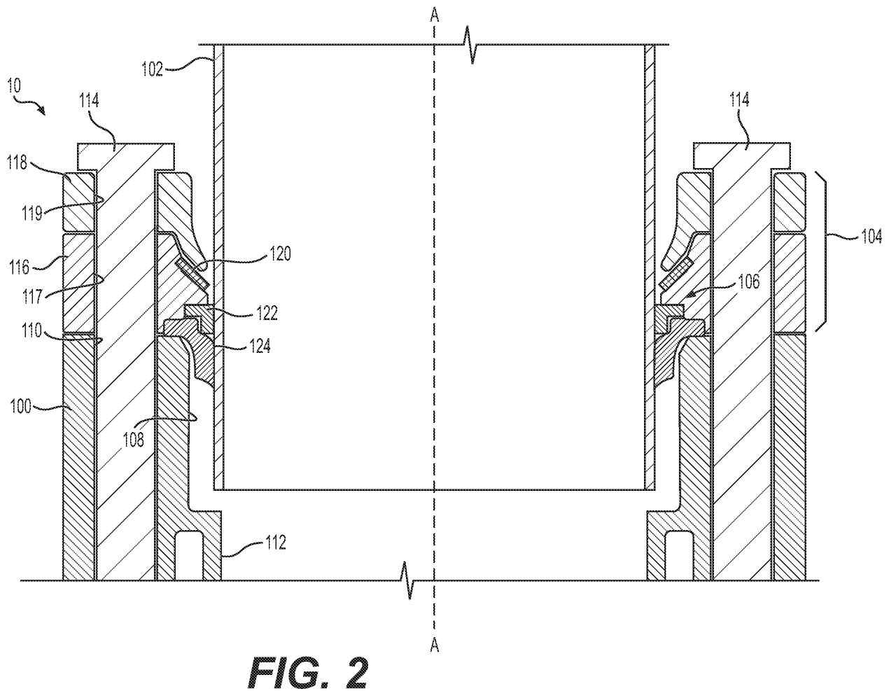

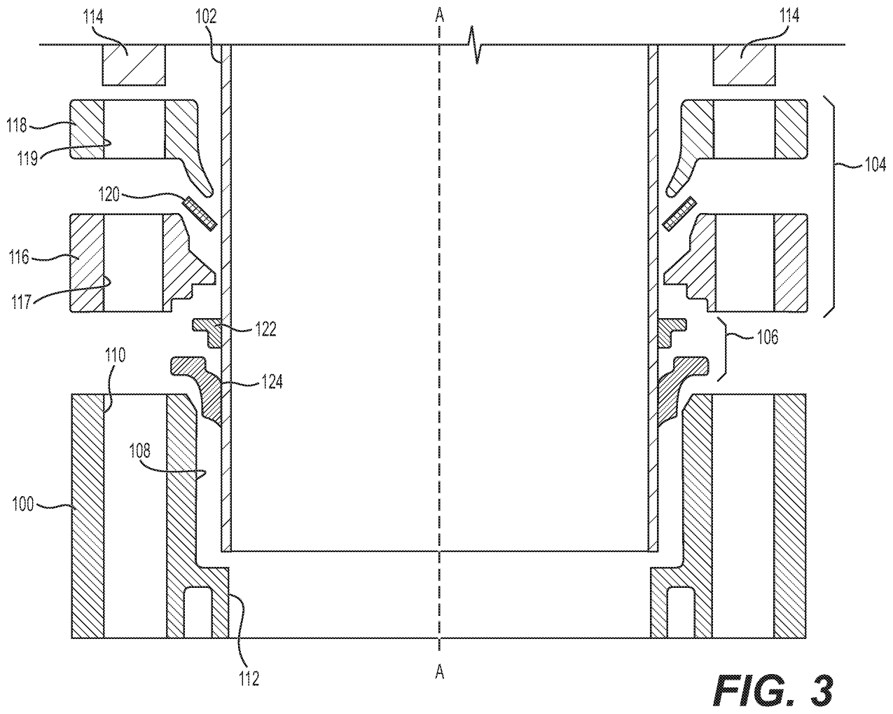

FIG. 2 is a detailed cross-sectional plan view of the sealed coupling 10 between the flange 100 and the tube 102. The sealed coupling 10 may include a clamp assembly 104 and a tube seal assembly 106. The clamp assembly 104 may be coupled to the flange 100 by a plurality of bolts 114 or other fasteners via peripherally-located openings 110. That is, a plurality of threaded bolts 114 may be provided. FIG. 2 shows a cross-sectional view of the sealed coupling 10 in an assembled configuration, and FIG. 3 shows a cross-sectional view of the sealed coupling 10 in an exploded plan view.

The flange 100 may include a main fluid channel 112 and an expanded tube opening 108 at an open end of the flange 100. The main fluid channel 112 and the expanded tube opening 108 may be generally cylindrical, although other shapes are possible. The flange 100 may be formed of a rigid material, such as steel.

The tube 102 may be cylindrical and formed of a material, such as steel, stainless steel, aluminum, polymerizing vinyl chloride (PVC), or ceramic, for example. An inner diameter of the tube 102 may be approximately equal to an inner diameter of the main fluid channel 112, and an outer diameter of the tube 102 may be smaller than the diameter of expanded tube opening 108, so as to be received therein.

The clamp assembly 104 may extend from an open end of flange 100, and may include a cap 118 and a clamp member 116 positioned between the cap 118 and the flange 100. An annular lock ring 120 may be positioned at an inner interface between the cap 118 and the clamp member 116. The clamp member 116 and the cap 118 may have generally the same shape, namely, a cylinder having a central opening generally corresponding in shape to the expanded tube opening 108 of the flange 100. Diameters of the central openings of the clamp member 116 and the cap 118 are generally the same as a diameter of the tube opening 108 of the flange 100. In addition, openings 117 and 119 are provided in the clamp member 116 and the cap 118, respectively, and are arranged to be coextensive with a clamp opening 110 in the flange 100. Each of the openings 110, 117, and 119 may be threaded, or just the clamp opening 110 may be threaded to engage with threads of bolts 114. The lock ring 120, which is an annular member, has a central opening generally corresponding in shape and size to the tube opening 108 of the flange 100.

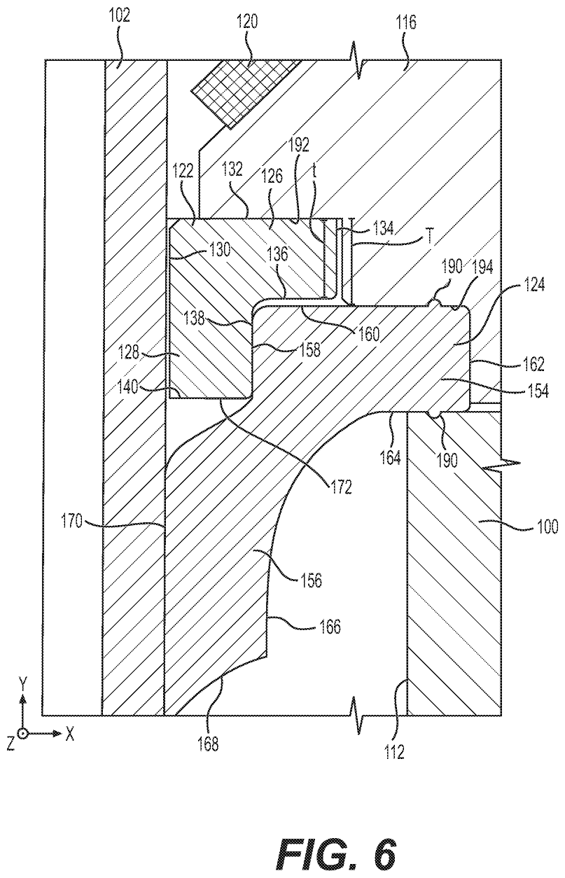

An inner circumferential surface of the clamp member 116 has a series of protrusions and grooves shaped to fit the lock ring 120 and the tube seal assembly 106. In particular, the inner circumferential surface of the clamp member 116 has an upper groove 192 and a lower groove 194 shaped to fit the tube seal assembly 106, as shown in FIG. 6. In addition, an inner circumferential surface of the cap 118 has a shape having a curved surface with an inwardly extending protrusion that extends along a portion of the inner circumferential surface of the clamp member 116, as shown in FIG. 2. The clamp member 116 may be formed of a relatively rigid material, such as metal, and, more specifically, steel.

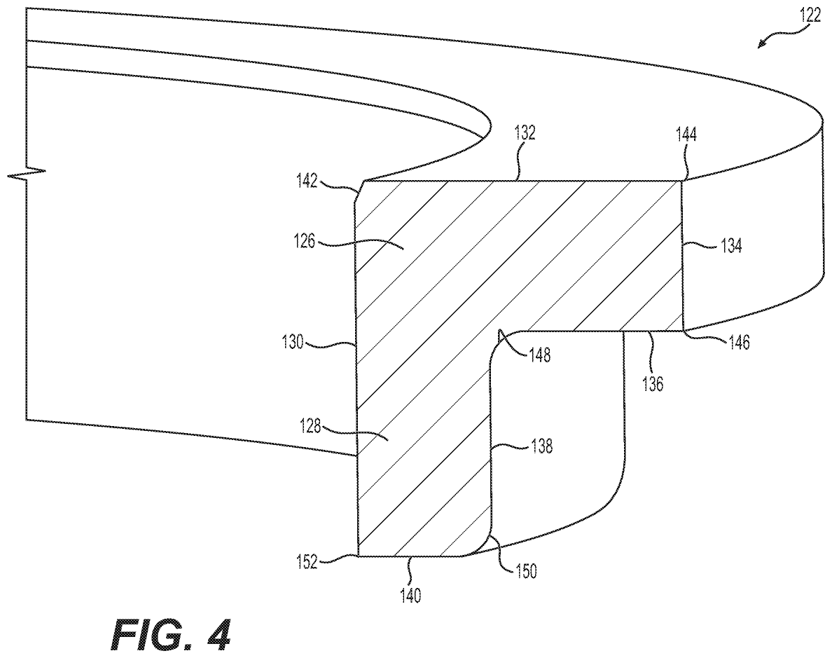

The tube seal assembly 106 may include a back-up ring 122 and a seal 124. Both the back-up ring 122 and the seal 124 are annular members, each having a central opening. Cutaway views of the back-up ring 122 and the seal 124 are shown in FIGS. 3 and 4, respectively. Before assembly with the back-up ring 122 and insertion between the flange 100 and the clamp member 116, the seal 124 is in an unloaded state, meaning the seal 124 is undeformed. As described below, after the tube seal assembly 106 is secured between the flange 100 and the clamp member 116, and the tube 102 is inserted into the tube opening 108 of the flange 100, the seal 124 is in a loaded state, meaning that the seal bends and/or deforms relative to the position in the unloaded state. In addition, as described below, the back-up ring 122 is configured to bend (i.e., change from an unbent state to a bent state) in response to at least tilting of the tube 102 relative to a longitudinal axis A-A of the flange 100.

Referring to FIG. 4, the back-up ring 122 may have a generally L-shaped cross section. The back-up ring 122 has a base or an upper portion 126 and a leg or a lower portion 128. The base 126 and the leg 128 are formed as a singular member. The base 126 may have two pairs of parallel, planar surfaces, and the leg 128 has one pair of parallel, planar surfaces, including a common inner surface with the base 126. The base 126 is defined by a portion of an inner surface 130, an upper surface 132, an outer surface 134, and a lower surface 136. The leg 128 is defined by an outer surface 138, a lower surface 140, and another portion of the inner surface 130. An inner diameter of the back-up ring 122, as defined by the inner surface 130, is generally the same as or slightly greater than a diameter of the tube 102. In addition, the base 126 has a thickness t that may be less than a thickness T of the upper groove 192 of the clamp member 116, as shown in FIG. 6.

As shown in FIG. 4, the inner surface 130 and the upper surface 132 of back-up ring 122 are generally planar and perpendicular to each other when the back-up ring 122 is in the unbent state, and an edge 142 between the inner surface 130 and the upper surface 132 may be a chamfered edge. The upper surface 132 and the outer surface 134 are generally planar and perpendicular to each other, and an edge 144 between the upper surface 132 and the outer surface 134 may be a square edge. The outer surface 134 and the lower surface 136 are generally planar and perpendicular to each other, and an edge 146 between the outer surface 134 and the lower surface 136 may be a square edge. The lower surface 136 and the outer surface 138 are generally planar and perpendicular to each other when the back-up ring 122 is in the unbent state, and an edge 148 between the lower surface 136 and the outer surface 138 may be a rounded edge. The outer surface 138 and the lower surface 140 are generally planar and perpendicular to each other, and an edge 150 between the outer surface 138 and the lower surface 140 may be a square edge or a rounded edge, as shown in FIG. 4. The lower surface 140 and the inner surface 130 are generally planar and perpendicular to each other, and an edge 152 between the lower surface 140 and the inner surface 130 may be a square edge. When the back-up ring 122 bends, i.e., changes from the unbent state to the bent state, an angle between the inner surface 130 and the upper surface 132, internally with respect to the base 126 of the back-up ring 122, may be an acute angle (i.e., between 0° and 90°). In addition, when the back-up ring 122 bends, an angle between the lower surface 136 and the outer surface, externally with respect to the base 126 of the back-up ring 122, may be an acute angle (i.e., between 0° and 90°).

The geometric relationships between the surfaces of the back-up ring 122 and the characteristics of the surfaces of the back-up ring 122 (e.g., planar) may vary from those described above. In addition, the details of the edges of the back-up ring 122 may vary from those described above.

The back-up ring 122 may be formed of a material that is relatively more rigid than the seal 124, and that is less hard than a metal. In addition, the back-up ring 122 is formed of a material that is flexible, meaning that the material has some elasticity and is soft enough bend. For example, the back-up ring 122 may be formed of polytetrafluoroethylene (PTFE), and, more specifically, glass-filled PTFE. The back-up ring 122 formed of PTFE may comprise 20% to 30% glass fill, and, more specifically, 25% glass fill.

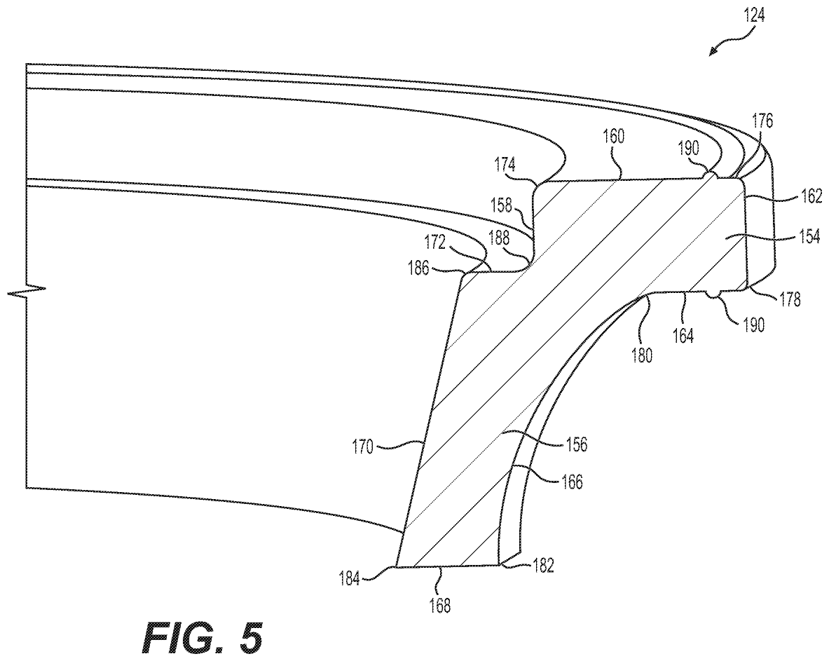

Referring to FIG. 5, the seal 124 may include a base or an upper portion 154 and a leg or a lower portion 156. The base 154 may have two pairs of parallel, planar surfaces, and the leg 156 may have one pair of parallel, planar surfaces. The leg 156 may extend radially inward from the base 154 at an angle. The base 154 is defined by an inner surface 158, an upper surface 160, an outer surface 162, and a lower surface 164. The leg 156 is defined by an outer surface 166, a lower surface 168, an inner surface 170, and an upper surface 172. The leg 156 forms an energized lip seal, as is discussed below with reference to FIG. 6.

The inner surface 158 and the upper surface 160 are generally planar and perpendicular to each other, and an edge 174 between the inner surface 158 and the upper surface 160 may be a rounded edge. The upper surface 160 and the outer surface 162 are generally planar and perpendicular to each other, and an edge 176 between the upper surface 160 and the outer surface 162 may be a rounded edge. The outer surface 162 and the lower surface 164 are generally planar and perpendicular to each other, and an edge 178 between the outer surface 162 and the lower surface 164 may be a square edge.

The lower surface 164 and the outer surface 166 are generally angled relative to each other, with the outer surface 166 being a curved surface, as shown in FIG. 5. An angle between the lower surface 164 and the outer surface 166, externally with respect to the leg 156 of the seal 124, may be an obtuse angle (i.e., between 90° and 180°) at least when the seal 124 is in the unloaded state. An edge 180 between the lower surface 164 and the outer surface 166 may be a blended edge. The curved outer surface 166 and the lower surface 168 are generally angled relative to each other, and an edge 182 between the bottom of the curved outer surface 166 and the lower surface 168 may be a square edge when the seal 124 is in the unloaded state. The lower surface 168 and the inner surface 170 are generally planar and angled relative to each other at least when the seal 124 is in the unloaded state, with an edge 184 formed between the lower surface 168 and the inner surface 170. An angle between the lower surface 168 and the inner surface 170, internally with respect to the leg 156 of the seal 124, may be an acute angle. The inner surface 170 and the upper surface 172 are generally planar and angled relative to each other, with an edge 186 formed between the inner surface 170 and the upper surface 172. An angle between the inner surface 170 and the upper surface 172, internally with respect to the leg 156 of the seal 124, may be an obtuse angle, at least when the seal 124 is in the unloaded state. Finally, the upper surface 172 and the inner surface 158 are generally planar and perpendicular to each other, and an edge 188 between the upper surface 172 and the inner surface 158 may be a rounded edge. In addition, the upper surface 172 and the lower surface 168 are parallel to each other at least when the seal 124 is in the unloaded state. Further, the upper surface 172 and the inner surface 158 form a groove in which the back-up member 122 is configured to sit. When the seal 124 bends in the loaded state, the angle between the lower surface 164 and the outer surface 166 and the angle between the inner surface 170 and the upper surface 172 may decrease, and the angle between the lower surface 168 and the inner surface 170 may increase.

In one embodiment, at least one stress concentrator 190 may be provided on the upper surface 160 and/or the lower surface 164 of the base 154 of the seal 124. The stress concentrator 190 improves contact pressure between the base 154 of the seal 124 and the clamp member 116 and/or the flange 100.

The seal 124 is flexible, in that it may be formed of any material having elasticity and being soft enough to adequately mate and comply to the sealing surfaces of the tube 102, the flange 100, and the clamp member 116, while bending and holding up to the fluid contained in the main fluid channel 112. For example, the seal 124 may be formed of rubber, such as ethylene propylene diene monomer (EPDM) rubber having a hardness value, as measured by the Shore hardness scale, of 75 duro. Alternatively, the seal 124 may be formed of hydrogenated nitrile butadiene rubber (HNBR), or a fluoroelastomer (FKM). The seal 124 may be relatively more flexible than the back-up ring 122.

The geometric relationships between the various surfaces of the seal 124 may vary from those described above. In addition, the details of the edges of the seal 124 may vary from those described above. Further, shapes of the surfaces (i.e., flat surfaces, curved surfaces) may vary from those described above and shown in the figures. In particular, the outer surface 166 of the leg 156 of the seal 124 may be a flat surface.

### INDUSTRIAL APPLICABILITY

The sealed coupling 10 of the present disclosure may provide a fluid-tight seal between two members, e.g., the flange 100 and the tube 102, that are fixed together using the clamp assembly 104, while allowing for some movement of the tube 102 relative to the flange 100 and the clamp assembly, and accommodating misalignment between the tube 102 and one or both of the flange 100 and the clamp assembly 104. Further, the sealed coupling 10 forms a semi-enclosed static joint between the tube 102, the flange 100, and the clamp member 116 of the clamp assembly 104 when the clamp assembly 104 is secured to the flange 100. That is, the tube seal assembly 106 of the sealed coupling 10 provides a movable, floatable seal that accommodates compression when the clamp member 116 of the clamp assembly 104 is tightened and secured to the flange 100.

Referring to FIG. 2, when the flange 100, the tube 102, the clamp assembly 104, and the tube seal assembly 106 are assembled and/or tightened (i.e., secured using the plurality of bolts 114), the tube opening 108 of the flange 100 aligns with the central opening of the clamp member 116 and the central opening of the cap 118, and the clamp openings 110 in the flange 100 align with the openings 117 in the clamp member 116 and the openings 119 in the cap 118. Each of the plurality of bolts 114 is inserted into one opening 119 in the cap 118, one opening 117 in the clamp member 116, and one clamp opening 110 in the flange 100, and may be secured via an appropriately located threaded connection. Thus, with the tube 102 in position within tube opening 108, bolts 114 fixedly secure cap 118, clamp member 116, and flange 100 together—and secure tube 102 to flange 100. In this assembled position, central openings of the lock ring 120, the back-up ring 122, and the seal 124 align with the tube opening 108 of the flange 100.

When the tube 102 is inserted through the central openings of the cap 118, the lock ring 120, the clamp member 116, the back-up ring 122, and the seal 124, respectively, and into the tube opening 108 of the flange 100, an outer surface of the tube 102 contacts at least the seal 124 and the seal 124 changes from the unloaded state to the loaded state.

FIG. 6 shows a detail cross-sectional view of relative positions of the flange 100, the tube 102, the clamp assembly 104, and the tube seal assembly 106 when assembled, and before the clamp assembly 104 is secured to the flange 100. The back-up ring 122 sits between the clamp member 116, the seal 124, and the tube 102. More specifically, with regard to the base 126 of the back-up ring 122, the inner surface 130 may be slightly spaced from the tube 102, and the upper surface 132 may be spaced from a lower surface of the clamp member 116, i.e., a surface of the upper groove 192. In addition, the outer surface 134 may be slightly spaced from an inner surface of the clamp member 116, i.e., another surface of the upper groove 192, and the lower surface 136 may be spaced from a portion of the upper surface 160 of the base 154 of the seal 124 by virtue of the relationship between the thickness t of the base 126 of the back-up ring 122 and the thickness T of the upper groove 192. With regard to the leg 128 of the back-up ring 122, the inner surface 130 may be slightly spaced from the tube 102, the lower surface 140 is spaced from the upper surface 172 of the leg 156 of the seal 124, and the outer surface 138 contacts the inner surface 158 of the base 154 of the seal 124.

Referring to FIG. 6, the seal 124 sits between the back-up ring 122, the clamp member 116, the flange 100, and the tube 102. As noted above, with regard to the base 154 of the seal 124, the inner surface 158 contacts the outer surface 138 of the leg 128 of the back-up ring 122, and a portion of the upper surface 160 may be spaced from the lower surface 136 of the base 126 of the back-up ring 122. Another portion of the upper surface 160 and the outer surface 162 contact the lower groove 194 of the clamp member 116, and a portion of the lower surface 164 contacts an upper surface of the flange 100. Another portion of the lower surface 164 of the base 154 of the seal 124 and the curved outer surface 166 and the lower surface 168 of the leg 156 of the seal 124 are positioned in the main fluid channel 112 of the flange 100. As discussed in more detail below, the leg 156 of the seal 124 forms an energized seal against the tube 102 when the seal 124 is in the loaded state, with at least a portion of the inner surface 170 contacting the tube 102. And, as noted above with respect to the back-up ring 122, the upper surface 172 of the leg 156 of the seal 124 is spaced from the lower surface 140 of the leg 128 of the back-up ring 122 when the seal 124 is in the loaded state.

A fit between the inner surface 130 of the back-up ring 122 and the tube 102 may be as close to a sliding line-to-line fit as possible. A fit between the outer surface 162 of the base 154 of the seal 124 and the clamp member 116 may be a tight clearance fit. Surfaces of the seal 124 that contact the flange 100, the clamp member 116, and the tube 102 may have a surface roughness Ra of 0.2 μm to 15 μm. In addition, edges of the seal 124 that contact the clamp member 116, the flange 100, and the tube 102 may be semi-smooth edges without burrs.

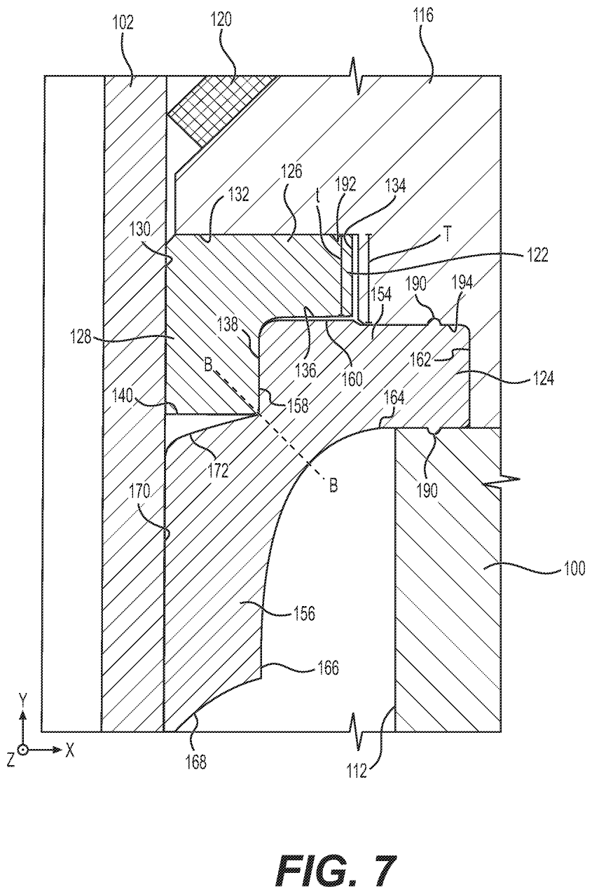

When the tube 102 is inserted into the flange 100, the clamp assembly 104, and the seal assembly 106, and these elements are secured using the plurality of bolts 114, the seal 124 may deform, as it changes from the unloaded state to the loaded state, to ensure a fluid tight seal between the tube 102, the flange 100, and the clamp assembly 104. FIG. 7 shows a detail cross-sectional view of the tube seal assembly 106 when the clamp assembly 104 and the flange 100 are secured together using the plurality of bolts 114.

After the clamp assembly 104 is secured to the flange 100, with regard to the base 126 of the back-up ring 122, as shown in FIG. 7, the inner surface 130 may contact the tube 102, the upper surface 132 contacts a lower surface of the clamp member 116, i.e., the surface of the upper groove 192, the outer surface 134 may be spaced from the inner surface of the upper groove 192 of the clamp member 116, and the lower surface 136 may remain slightly spaced from the portion of the upper surface 160 of the base 154 of the seal 124. With regard to the leg 128 of the back-up ring 122, the inner surface 130 contacts the tube 102, the lower surface 140 is spaced from the upper surface 172 of the leg 156 of the seal 124, and the outer surface 138 contacts the inner surface 158 of the base 154 of the seal 124.

In addition, when the clamp assembly 104 is secured to the flange 100, and the seal 124 is in the loaded state, the base 154 of the seal 124 expands, while the upper surface 160 of the base 154 may remain slightly spaced from the back-up ring 122, and the leg 156 of the seal 124 remains energized against the tube 102. That is, the seal 124 is compressed as a result of the clamp member 116 being secured to the flange 100, and, therefore, expands to at least partially fill the space between the base 154 of the seal 124 and the base 126 of the back-up ring 122. As shown in FIG. 7, the inner surface 158 of the base 154 of the seal 124 contacts the outer surface 138 of the leg 128 of the back-up ring 122. The portion of the upper surface 160 of the seal 124 may remain slightly spaced from the lower surface 136 of the base 126 of the back-up ring 122. The other portion of the upper surface 160 and the outer surface 162 sit in the lower groove 194 of the clamp member 116, and a portion of the lower surface 164 contacts the upper surface of the flange 100. Another portion of the lower surface 164 of the base 154 of the seal 124, and the curved outer surface 166 and the lower surface 168 of the leg 156 of the seal 124 sit in the main fluid channel 112 of the flange 100. The inner surface 170 of the leg 156 of the seal 124 contacts the tube 102. And, as noted above with respect to the back-up ring 122, the upper surface 172 of the leg 156 of the seal 124 is spaced from the lower surface 140 of the leg 128 of the back-up ring 122.

A pressure of fluid that flows through the main fluid channel 112 of the flange 100 exerts a force on the surfaces of the seal 124 that sit in the main fluid channel 112, i.e., a portion of the lower surface 164 of the base 154, and the curved outer surface 166 and the lower surface 168 of the leg 156. As a result of the force from the pressure of the fluid, the seal 124 exerts a force on the tube 102. The force of the seal 124 on the tube 102 is, at least in part, a function of the pressure of the fluid in the main fluid channel 112, a function of a surface area of at least the outer surface 166 and the lower surface 168 of the leg 156 of the seal 124, and a function of the elasticity of the seal 124. As a result of the elasticity of the seal 124 and the force of the pressurized fluid on at least the outer surface 166 and the lower surface 168 of seal 124, the seal 124 forms an energized lip seal against the tube 102. The seal 124 thus forms a fluid-tight seal between the tube 102 and the flange 100 when in the loaded state.

In addition, the back-up ring 122 provides a gap into which the base 154 of the seal 124 can expand as it deforms or compresses when the clamp member 116 is secured to the flange 100. That is, with reference to FIG. 7, as the base 154 of the seal 124 deforms when the seal 124 is in the loaded state, the base 154 of the seal 124 expands and causes the back-up ring 122 to shift so that the inner surface 130 of the back-up ring 122 may contact the tube 102. Further, the relationship between the thickness t of the base 126 of the back-up ring 122 and the thickness T of the upper groove 192 of the clamp member 116 ensures a gap is formed between the back-up ring 122 and the seal 124. The back-up ring 122 thus accommodates expansion of the base 154 of the seal 124 by providing the gap to be filled once the clamp assembly 104, and, more specifically, once the clamp member 116 is secured to the flange 100. And, due to the back-up ring 122 being formed of a relatively more rigid material than that of the seal 124, the back-up ring 122 acts as a load-limiter in helping to prevent over-compression of the seal 124 by limiting the space in which the seal 124 can expand as it deforms in the loaded state. In addition, the back-up ring 122 prevents the base 154 of the seal 124 from expanding into a narrow space between the tube 102 and the clamp member 116, which helps prevent splitting or extrusion of the seal 124.

In addition, when the flange 100, the tube 102, the clamp assembly 104, and the tube seal assembly 106 are assembled and secured with the plurality of bolts 114, the tube seal assembly 106 allows for and complies with tilt and translation of the tube 102 within the flange 100, the clamp assembly 104, and the tube seal assembly 106, while maintaining the fluid tight seal with the tube 102. That is, even if the tube 102 is secured at a tilt or an angle, for example, up to 3°, and/or translates or shifts laterally, for example, up to 1.5 mm, with respect to the longitudinal axis A-A of the flange 100, the seal 124 remains energized against the tube 102 to maintain a fluid-tight seal.

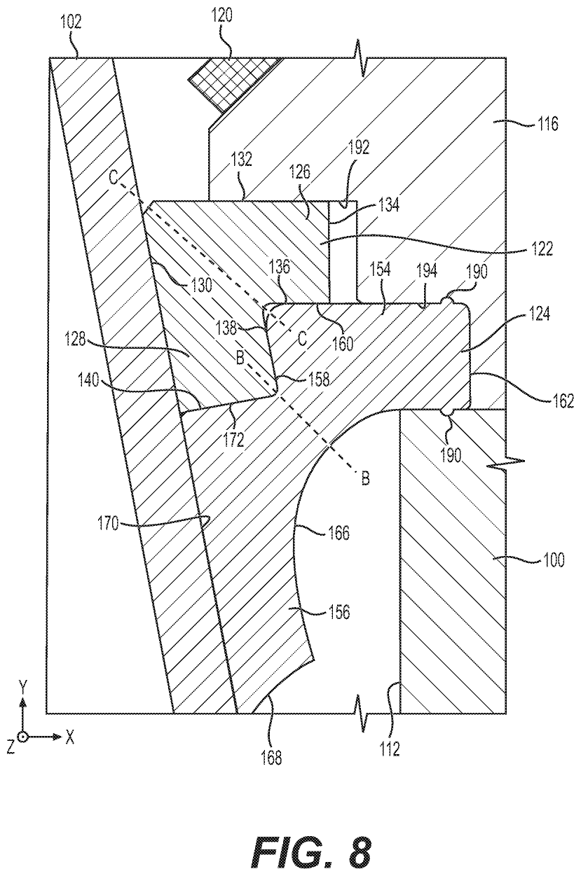

With reference to FIG. 8, if the tube 102 is angled or tilted with respect to the longitudinal axis A-A (FIGS. 2 and 3) of the flange 100, a position of the back-up ring 122 changes. Specifically, the back-up ring 122 shifts laterally with respect to the tube 102, and the leg 128 of the back-up ring 122 bends relative to the base 126 of the back-up ring 122 with respect to a plane, shown as a line C-C and extending in the z-direction. In addition, the leg 156 of the seal 124, which is in the loaded state, bends relative to the base 154 of the seal 124 with respect to a plane, shown as a line B-B and extending in the z-direction. That is, if the tube 102 tilts about a z-axis (i.e., an axis passing into the page), the back-up ring 122 shifts laterally along an x-axis and bends with respect to the plane shown as line C-C, so that a space between the outer surface 134 of the base 126 of the back-up ring 122 and the clamp member 116 increases, while the inner surface 130 of the back-up ring 122 abuts against the tube 102. In addition, the leg 156 of the seal 124 bends with respect to the plane shown as line B-B, relative to the base 154 of the seal 124, and the inner surface 170 of the leg 156 of the seal 124 abuts against the tube 102. The plane shown as line C-C may be parallel to the plane shown by line B-B. By virtue of this arrangement, a fluid tight seal is maintained between the tube 102, the flange 100, and the clamp assembly 104 even when the tube 102 tilts with respect to the longitudinal axis A-A of the flange 100.

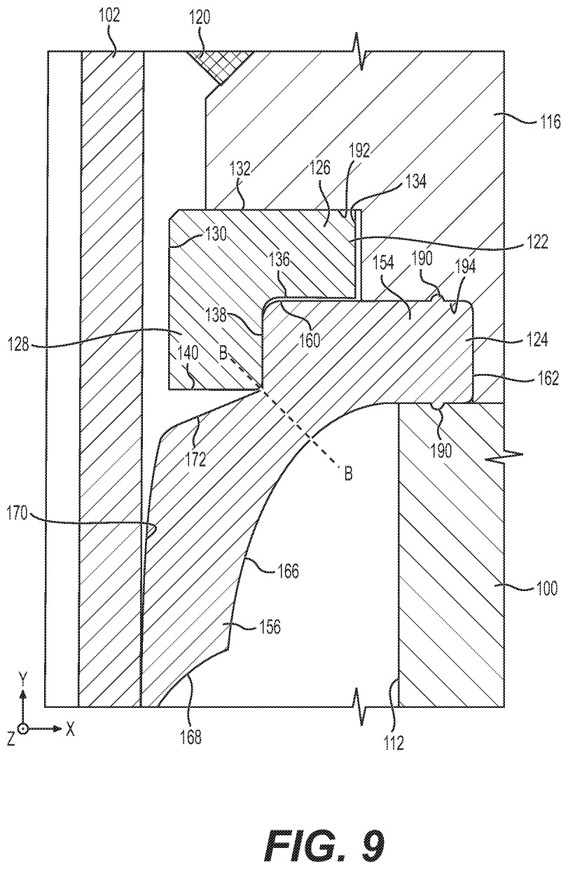

With reference to FIG. 9, if the tube 102 translates laterally with respect to the longitudinal axis A-A of the flange 100, the position of the backup ring 122 does not necessarily change from that shown in FIG. 7, but the leg 156 of the seal 124, which is in the loaded state, moves with the tube 102, and bends with respect to line B-B relative to the base 154 of the seal 124. That is, if the tube 102 shifts laterally along the x-axis, the back-up ring 122 and the base 154 of the seal 124 may remain in the same positions as shown in FIG. 7, and the seal 124 bends with respect to the line B-B, so that the leg 156 of the seal 124 moves with the tube 102. The leg 156 of the seal 124 moves with the tube 102 partly due to the elasticity of the material that forms the seal 124, and partly due to the force of the pressurized fluid in the main fluid channel 112 of the flange 100 acting on the outer surface 166 and the lower surface 168 of the leg 156 of the seal 124.

In the embodiment shown in FIGS. 6-9, in order to ensure that the seal 124 maintains an energized lip seal against the tube 102, a surface area of the outer surface 166 is greater than a surface area of the lower surface 168 of the leg 156 of the seal 124. As a result, a force of the pressurized fluid on the leg 156 of the seal 124 is greater in the x-direction, i.e., a direction radially inward toward the longitudinal axis A-A of the flange, than in the y-direction, i.e., a vertical direction in FIGS. 6-9. This relationship between the forces in the x-direction and the y-direction ensures that the seal 124 remains energized against the tube 102.

By virtue of the tube seal assembly 106 of the present disclosure, a fluid-tight seal between at least the clamp member 116, the flange 100, and the tube 102 can be maintained once the clamp assembly 104 is secured to the flange 100, even if the tube 102 tilts and/or shifts with respect to the longitudinal axis A-A of the flange 100. In addition, the tube seal assembly 106 provides an energized lip seal as a fluid-tight seal between the flange 100, the tube 102, and the clamp assembly 104, both before and after the clamp assembly 104 is secured to the flange 100. The tube seal assembly 106 is thus suited for high pressure tube seal applications with high system misalignments in the form of translation and/or tilting of the tube 102 relative to the flange 100.

Further, the back-up ring 122 of the tube seal assembly 106 provides an L-shaped groove for the base 154 of the seal 124, which provides volume within which the seal 124 can expand during compression (i.e., during securing of the clamp assembly 104 to the flange 100), while helping to prevent over-compression, splitting, and/or extrusion of the seal 124. That is, the back-up ring 122 and the base 154 of the seal 124 form a semi-closed groove seal.

Still further, the tube seal assembly 106 provides a flexible joint that isolates vibration between the tube 102 and the flange 100. That is, by virtue of the seal 124 being formed of an elastic, soft material, and the back-up ring 122 being formed of a relatively more rigid material that is less hard than a metal, contact between the tube 102 and the flange 100 can be prevented. As a result, unlike conventional fittings, vibration in either one of the tube 102 and the flange 100 can be isolated, i.e., is not transmitted to the other one of the tube 102 and the flange 100, by the tube seal assembly 106.

The tube seal assembly 106 of the present disclosure has a two piece symmetrical design that provides for easy installation and assembly. That is, the cross-sectional L-shape of the back-up ring 122 is suited to fit over the inner surface 158 and the upper surface 160 of the base 154 of the seal 124, providing for easy assembly of the tube seal assembly 106.

It will be apparent to those skilled in the art that various modifications and variations can be made to the disclosed system without departing from the scope of the disclosure. Other embodiments of the system will be apparent to those skilled in the art from consideration of the specification and practice of the lift capacity system disclosed herein. It is intended that the specification and examples be considered as exemplary only, with a true scope of the disclosure being indicated by the following claims and their equivalents.

What is claimed is:

1. An unloaded annular flexible seal for use in a seal assembly configured to receive an end of a conduit and to provide a seal between the conduit and a flange of a machine, the seal comprising:
a base having an inner surface, an upper surface, an outer surface, and a lower surface; and
a leg having an inner surface, an upper surface extending from the inner surface of the base, an outer surface extending from the lower surface of the base, and a lower surface,
wherein a surface area of the outer surface of the leg is greater than a surface area of the lower surface of the leg.

2. The seal of claim 1, wherein the inner surface of the base and the upper surface of the leg of the seal form a groove.

3. The seal of claim 1, wherein the outer surface of the leg is curved.

4. The seal of claim 1, wherein the base has two pairs of parallel surfaces.

5. The seal of claim 1, wherein the leg extends radially inward from the base at an angle.

6. A seal assembly configured to receive an end of a conduit and to provide a seal between the conduit and a flange of a machine, the seal assembly comprising:
an annular flexible seal that includes:
a seal base having an inner surface, an upper surface, an outer surface, and a lower surface; and
a seal leg having an inner surface, an upper surface extending from the inner surface of the seal base, thereby forming a groove, an outer surface extending from the lower surface of the seal base, and a lower surface,
wherein a surface area of the outer surface of the seal leg is greater than a surface area of the lower surface of the seal leg; and
an annular back-up member having an L-shaped cross section, including a back-up member base and a back-up member leg configured to sit in the groove of the flexible seal.

7. The seal assembly of claim 6, wherein the outer surface of the seal leg is curved.

8. The seal assembly of claim 6, wherein the seal base has two pairs of parallel surfaces, and the back-up member has an L-shaped cross-section.

9. The seal assembly of claim 6, wherein the seal leg extends radially inward from the seal base at an angle.

10. The seal assembly of claim 6, wherein the surfaces of the seal base and surfaces of the back-up member base and the back-up member leg are planar, and at least the outer surface of the seal leg is curved.

11. The seal assembly of claim 6, wherein a stiffness of the back-up member is greater than a stiffness of the seal.

12. A seal assembly configured to provide a fluid-tight seal between a tube, a flange, and a clamp, the seal assembly comprising:
an annular flexible seal including:
a seal base having an inner surface, an upper surface, an outer surface, the upper surface and the outer surface being configured to sit in a groove formed by the clamp and the flange, and a lower surface; and
a seal leg having an inner surface, an upper surface extending from the inner surface of the seal base, thereby forming a groove, an outer surface extending from the lower surface of the seal base, and a lower surface,
wherein a surface area of the outer surface of the seal leg is greater than a surface area of the lower surface of the seal leg; and
an annular back-up member having an L-shaped cross section, including a back-up member base configured to sit in a groove of the clamp, and a back-up member leg configured to sit in the groove of the seal,
wherein, when the tube is inserted into the seal assembly, and the tube, the flange, the clamp, and the seal assembly are secured to each other, the seal base is compressed between the clamp, the flange, and the back-up member.

13. The seal assembly of claim 12, wherein the outer surface of the seal leg is curved.

14. The seal assembly of claim 12, wherein the seal base has two pairs of parallel surfaces, and the back-up member has an L-shaped cross-section.

15. The seal assembly of claim 12, wherein the seal leg extends radially inward from the seal base at an angle.

16. The seal assembly of claim 12, wherein the surfaces of the seal base and surfaces of the back-up member base and the back-up member leg are planar, and at least the outer surface of the seal leg is curved.

17. The seal assembly of claim 12, wherein the back-up member is configured to bend with respect to a first plane, and the seal is configured to bend with respect to a second plane.

18. The seal assembly of claim 18, wherein the first plane and the second plane are parallel to each other.

19. The seal assembly of claim 12, wherein a stiffness of the back-up member is greater than a stiffness of the seal.

20. The seal assembly of claim 12, wherein the seal leg forms an energized lip-seal.
